(19) United States
(12) Patent Application Publication
(10) Pub. No.: US 2019/0061079 A1
(43) Pub. Date: Feb. 28, 2019

(54) MACHINE TOOL, TOOL, AND CONTROL PROGRAM

(71) Applicant: OKUMA Corporation, Niwa-gun (JP)

(72) Inventor: Shoichi MORIMURA, Niwa-gun Aichi (JP)

(21) Appl. No.: 16/108,678

(22) Filed: Aug. 22, 2018

(30) Foreign Application Priority Data
Aug. 25, 2017 (JP) 2017-161966

(51) Int. Cl. B23Q 3/157; B23Q 37/00; G05B 19/418

(52) U.S. Cl. CPC B23Q 3/15713; B23Q 37/007; B23Q 2003/1558; G05B 19/41845; G05B 19/41825

(57) ABSTRACT

A machine tool including a tool holding unit and a workpiece holding unit includes: a clamper to which a part of a sub-tool, which is a separate tool from a main tool held by the tool holding unit alone, can be detachably connected; an attachment/detachment unit to which another part of the sub-tool can be detachably connected; a tool spindle that moves the clamper; an in-machine robot that moves the attachment/detachment unit; and a controller that controls driving of the tool spindle and the in-machine robot, to execute machining of a workpiece by the sub-tool.

### CROSS REFERENCE TO RELATED APPLICATION

The present application claims priority under 35 U.S.C. § 119 to Japanese Patent Application No. 2017-161966 filed on Aug. 25, 2017, and the entire disclosure of which is incorporated herein by reference.

### TECHNICAL FIELD

The present disclosure relates to a machine tool, a tool used in the machine tool, and a control program that causes the machine tool to execute machining by the tool.

### BACKGROUND

In the related art, there is demand for a machine tool that can execute various operations. In particular, in recent years, demand for a large-variation, small-volume production is becoming stronger, and execution of various machining operations by one machine tool is desired.

However, many of the machine tools in the related art can only execute one or two machining operations, and auxiliary operations. For example, a cutting-type machine tool can only execute rotary cutting machining and/or lathe-turning machining, and auxiliary operations such as a measuring operation. A configuration may be considered in which a dedicated mechanism is provided for each of the other machining operations in one machine tool, so that various machining operations may be executed by one machine tool. However, when a dedicated mechanism for each machining operation is provided, other problems may arise, such as an increase in the size of the machine tool and an increase in cost.

In consideration of the above, an advantage of the present disclosure lies in provision of a machine tool, a tool, and a control program which enable a larger number of variations of machining operations.

### SUMMARY

According to one aspect of the present disclosure, there is provided a machine tool including a tool holding unit and a workpiece holding unit, the machine tool comprising: a first connection unit to which a part of a sub-tool, which is a separate tool from a main tool which is held by the tool holding unit alone, can be detachably connected; a second connection unit to which another part of the sub-tool can be detachably connected; a first movable element that moves the first connection unit; a second movable element that moves the second connection unit; and a controller that controls driving of the first movable element and the second movable element, to execute machining of a workpiece by the sub-tool connected to the first connection unit and the second connection unit.

According to another aspect of the present disclosure, the controller may comprise a storage unit that stores sub-tool data including a characteristic of the sub-tool, and the controller may interpret machining program data instructed by an operator, to calculate a movement trajectory of the sub-tool and to control movements of the first movable element and the second movable element based on the movement trajectory and the sub-tool data stored in the storage unit.

According to another aspect of the present disclosure, the first movable element may be a tool holding unit that holds a rotating tool or a lathe-turning tool as the main tool, and the first connection unit may be an attachment unit of the main tool provided on the tool holding unit.

According to another aspect of the present disclosure, the second movable element may be a robot provided in a machining chamber of the machine tool. In this case, the controller may control the first movable element by position control having a position as a control target, and may control the second movable element by force control having a force as a control target.

According to another aspect of the present disclosure, the machine tool may comprise a first tool holding unit and a second tool holding unit that hold a rotating tool or a lathe-turning tool as a main tool, the first movable element may be the first tool holding unit, and the second movable element may be the second tool holding unit.

According to another aspect of the present disclosure, the machine tool may further comprise: a motive force source that produces a motive force independently from the first movable element and the second movable element; and a transfer mechanism that transfers a motive force produced by the motive force source to a machining unit provided on the sub-tool connected to the first connection unit and the second connection unit, and a workpiece may be machined by the machining unit driven by the motive force.

According to another aspect of the present disclosure, there is provided a tool to be detachably connected to a first movable element and a second movable element provided in a machine tool, the tool comprising: a first connected unit to be detachably connected to the first movable element; a second connected unit to be detachably connected to the second movable element; and a machining unit that contacts a workpiece and machines the workpiece.

According to another aspect of the present disclosure, the tool may further comprise a joint that changes an orientation of the machining unit with respect to the first connected unit and/or the second connected unit, on at least one of between the machining unit and the first connected unit and between the machining unit and the second connected unit.

According to another aspect of the present invention, there is provided a control program of a machine tool that executes machining of a workpiece by one sub-tool connected to a first movable element and a second movable element, the program, when executed, causing: a storage unit provided in the machine tool to store sub-tool data including a characteristic of the sub-tool; and a controller provided in the machine tool to interpret machining program data instructed by an operator, to calculate a movement trajectory of the sub-tool and to control movements of the first movable element and the second movable element based on the calculated movement trajectory and the sub-tool data.

According to the technique of the present disclosure, because one sub-tool is connected to two movable elements, a machining operation which has been difficult to realize in the machine tool of the related art can be enabled, and a larger number of variations of machining can be enabled.

### BRIEF DESCRIPTION OF DRAWINGS

Embodiment(s) of the present disclosure will be described by reference to the following figures, wherein:

FIG. 1 is a diagram showing a structure of a machine tool;

FIG. 2 is a diagram showing an example of a sub-tool;

FIG. 3 is a diagram showing the sub-tool of FIG. 2 from a side;

FIG. 4 is a diagram showing another example of the sub-tool:

FIG. 5 is a diagram showing a structure of a tool spindle suited for use of the sub-tool shown in FIG. 4;

FIG. 6 is a diagram showing another example of the sub-tool;

FIG. 7 is a diagram showing another example of the sub-tool;

FIG. 8 is a diagram showing another example of the sub-tool; and

FIG. 9 is a diagram showing another example of the sub-tool.

### DESCRIPTION OF EMBODIMENTS

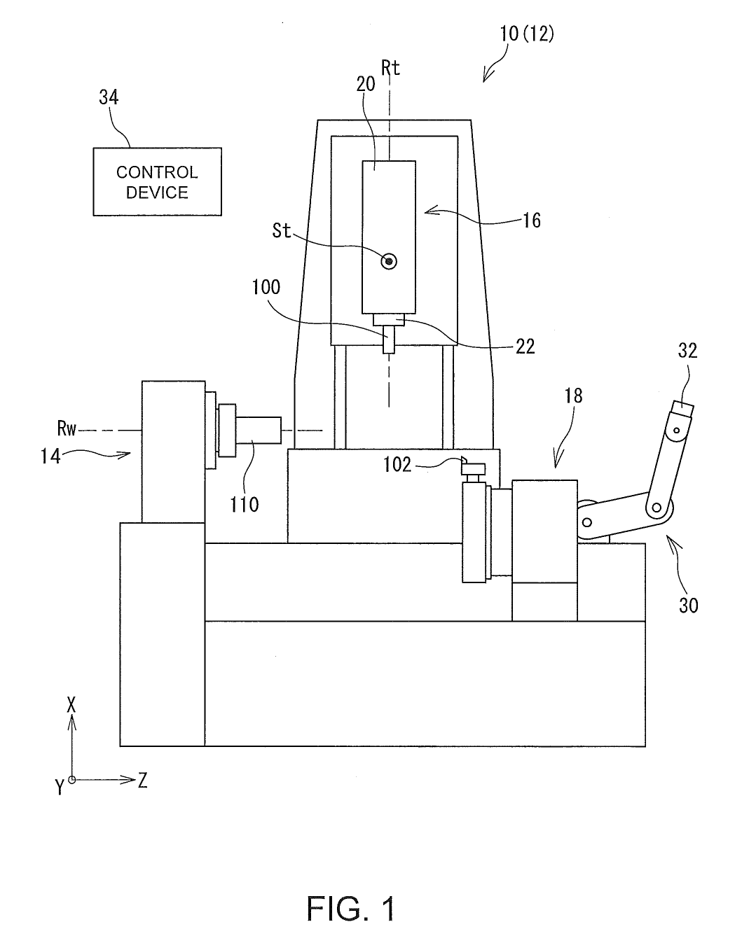

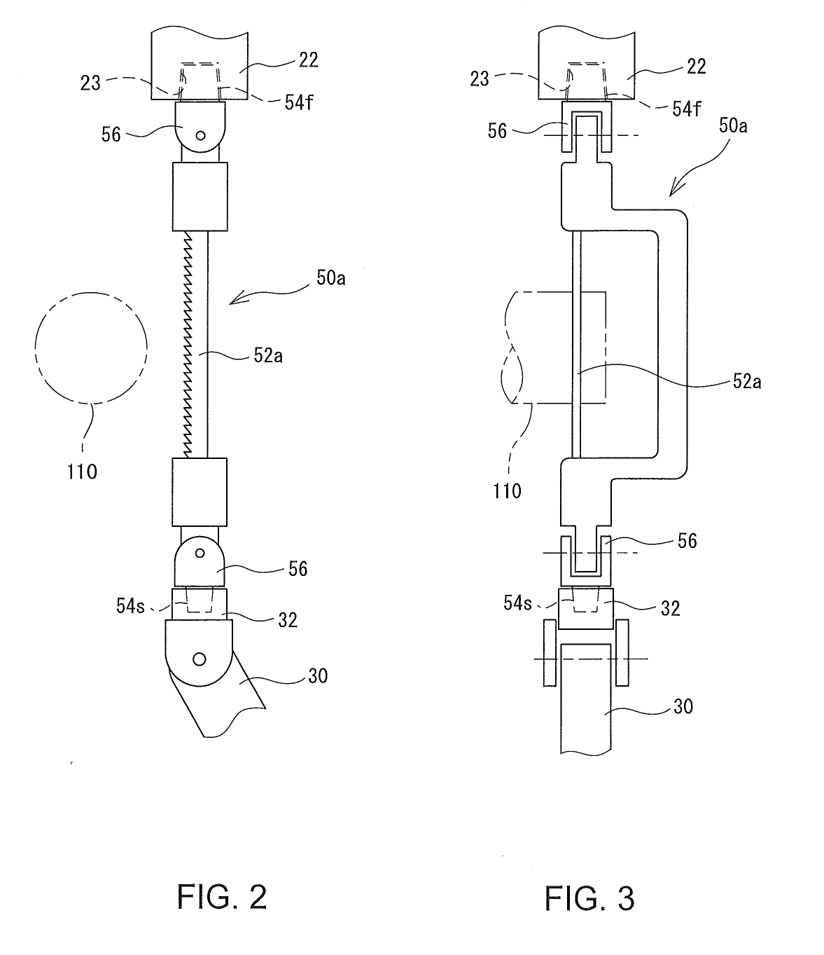

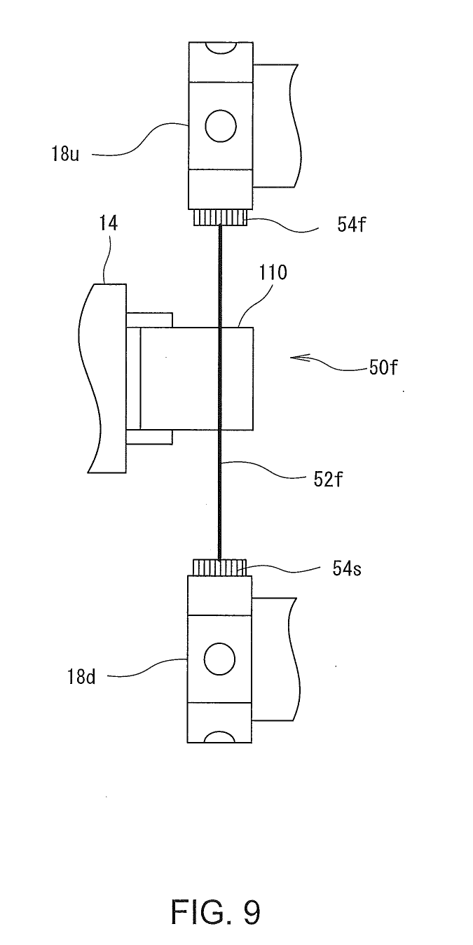

A structure of a machine tool 10 will now be described with reference to the drawings. FIG. 1 is a schematic diagram showing a structure of the machine tool 10. The machine tool 10 is a machine tool which executes cutting machining (rotary cutting machining and/or lathe-turn machining). A mechanical structure of the machine tool 10 is almost identical to that of a general-purpose machine tool except that the machine tool 10 has an in-machine robot 30 to be described later. In addition, a dedicated control program for enabling machining by sub-tools 50a-50f (refer to FIG. 2˜FIG. 9) to be described later is installed in a control device of the machine tool 10. In the following description, when the type of the sub-tool is not to be limited, the indices a˜f will be omitted, and the sub-tool will be referred to simply as a “sub-tool 50.”

More specifically, the machine tool 10 shown in FIG. 1 is a multi-tasking machine having a lathe-turning function to cause a lathe-turning tool 102 to contact a workpiece 110 while rotating the workpiece 110 and to cut the workpiece 110, and a rotary cutting function to cut the workpiece 110 by a rotating tool 100. A periphery of a main body part 12 of the machine tool 10 is covered by a cover (not shown). A space defined by the cover is a machining chamber in which the workpiece 110 is machined. On the cover, at least one opening and a door which opens and closes the opening (neither of which is shown in the figure) are provided. An operator accesses the main body part 12 of the machine tool 10 and the workpiece 110, or the like through the opening. During the machining, the door provided on the opening is closed. This is for ensuring safety and in consideration of the surrounding environment.

The main body part 12 comprises a workpiece spindle device 14 which holds the workpiece 110 in a self-rotatable manner, a tool spindle device 16 which holds the rotating tool 100 in a self-rotatable manner, and a tool post 18 which holds the lathe-turning tool 102. The workpiece spindle device 14 functions as a workpiece holding unit which holds the workpiece 110. The workpiece spindle device 14 comprises a chuck and a collet which detachably holds the workpiece 110, and the workpiece 110 which is held can be suitably exchanged. The workpiece spindle device 14 self-rotates about a workpiece rotation axis Rw which extends in a horizontal direction.

The tool spindle device 16 holds the rotating tool 100, for example, a tool which is called a fraise or an end mill in a self-rotatable manner, and comprises a spindle head 20 having a drive motor or the like built therein, and a tool spindle 22 attached on the spindle head 20. The tool spindle 22 can linearly move in the horizontal direction and a vertical direction, and can swing around a predetermined swing axis St.

On an end surface of the tool spindle 22, a clamper 23 (refer to FIG. 2) is formed to which a tool holder holding the rotating tool 100 can be attached in an insertable/detachable manner. In general, of the tool holder, a form of a shank inserted into the clamper 23 is defined in standards. The clamper 23 has a form corresponding to the standards.

The tool post 18 holds the lathe-turning tool 102, for example, a tool called a bite. The tool post 18 is connected to a two-axis linear movement mechanism, and a position with respect to the workpiece 110 can be changed.

Here, the tool spindle 22 and the tool post 18 both function as a tool holding unit which holds a tool (the rotating tool 100 or the lathe-turning tool 102). In the following, a tool (the rotating tool 100 or the lathe-turning tool 102) which is held by the tool holding unit alone will be referred to as a “main tool.” On the other hand, a tool which is connected to and held by two movable elements as will be described later is referred to as a “sub-tool 50.” In the present embodiment, the tool spindle 22 functions also as a first movable element connected to a part of the sub-tool 50. In addition, the clamper 23 on which the main tool is attached functions also as a first connection unit to which a part of the sub-tool 50 is detachably attached.

Further, in the machining chamber, the in-machine robot 30 is provided. No particular limitation is imposed on the structure of the in-machine robot 30 so long as the in-machine robot 30 is at least provided in the machining chamber and a position or an orientation of the in-machine robot 30 can be changed. Therefore, as shown in FIG. 1, the in-machine robot 30 may be an articulated robot having a plurality of arms connected via joints (a serial link robot). As another configuration, the in-machine robot 30 may be a parallel link robot in which a motion of one point is controlled by parallel links. In the following, an example case will be described in which the in-machine robot 30 is an articulated robot. The in-machine robot 30 can move independently from the tool spindle 22 and the tool post 18, and functions also as a second movable element connected to the sub-tool 50, to be described later.

The in-machine robot 30 has an attachment/detachment unit 32 which functions as a second connection unit to which a part of the sub-tool 50 can be detachably attached. No particular limitation is imposed on the form of the attachment/detachment unit 32 so long as a part of the sub-tool 50 is detachable, and in the present embodiment, as shown in FIG. 2, the attachment/detachment unit 32 has a taper-type clamper. In addition, the attachment/detachment unit 32 may be provided anywhere on the in-machine robot 30 so long as the attachment/detachment unit 32 can be displaced along with the driving of the in-machine robot 30, and may be provided, for example, at a tip of the in-machine robot 30 or at a central portion of the in-machine robot 30. In the following description, an example configuration will be described in which the attachment/detachment unit 32 is provided at the tip of the in-machine robot 30.

A control device 34 controls driving of various parts of the machine tool 10 according to instructions from the operator. The control device 34 comprises, for example, a CPU which executes various calculations and a memory which stores various control programs and control parameters. The control device 34 also has a communication function, and can exchange various data, for example, NC program data (machining program data) or the like with the other devices. The control device 34 may include, for example, a numerical control apparatus which continuously calculates positions of the tool and the workpiece 110. The control device 34 may be formed as a single device or a combination of a plurality of computation devices.

A dedicated control program for executing machining by the sub-tool 50 to be described later is installed in the control device 34. The control program stores in the memory sub-tool data which are data related to the sub-tool 50. The sub-tool data are data including a characteristic of the sub-tool 50, which include a tool type, and a size of the sub-tool 50. The sub-tool data further includes identification information of the first and second movable elements (the tool spindle 22 and the in-machine robot 30 in the present embodiment) to which the sub-tool 50 is connected. Various information forming the sub-tool data may be manually input by the operator. Alternatively, as another configuration, sub-tool data which are prepared in advance may be transmitted to the control device 34 through a wire or wirelessly. Further, the machine tool may have a function to edit as necessary the sub-tool data which are once stored.

When machining is to be executed using the sub-tool 50, the operator inputs the machining program data (NC program data) indicating the contents of the machining to the control device 34. According to the control program, the control device 34 interprets the machining program data which are input from the operator, and calculates a movement trajectory of the sub-tool 50. In addition, the control device 34 controls the movements of the first and second movable elements (the tool spindle 22 and the in-machine robot 30 in the present embodiment) based on the calculated movement trajectory and the sub-tool data stored in the memory.

As is clear from the above description, in the machine tool 10 of the present disclosure, one sub-tool 50 is connected to two movable elements, and the workpiece 110 is machined by the sub-tool 50. With such a configuration, a larger number of variations of machining can be enabled.

That is, many of the machine tools of the related art can only execute one or two machining operations, and auxiliary operations. For example, a cutting-type machine tool 10 as shown in FIG. 1 can only execute the rotary cutting machining and/or lathe-turning machining, and auxiliary operations such as a measuring operation. If a dedicated mechanism for a machining operation desired to be executed is provided in one machine tool 10, various machining operations may be executed by the machine tool 10. However, when a dedicated mechanism is provided for each machining operation, other problems may arise such as an increase in the size of the machine tool and an increase in cost.

In the machine tool 10 of the present disclosure, in consideration of these problems, a connection unit to which the sub-tool 50 can be detachably connected is provided on each of the two movable elements provided in advance in the machine tool 10, to enable a machining operation using the sub-tool 50 connected to the two connection units.

By connecting one sub-tool 50 to the two movable elements via the two connection units, it becomes possible to move the sub-tool 50 by the two movable elements. In this case, a large-size, a heavyweight, a special-shape, or a special-motion tool which cannot be held by a single movable element alone can be handled. As a result, a machining operation which has been difficult to execute by the machine tool 10 of the related art can also be enabled.

Here, no particular limitation is imposed on the movable elements so long as the movable element is a movable element provided in the machine tool 10, and, for example, the movable element may be the tool spindle 22 which holds the rotating tool 100, the tool post 18 which holds the lathe-turning tool 102, the in-machine robot 30 provided in the machine tool 10, a tailstock which holds the other end of the workpiece 110, or the like. However, in the case of the cutting-type machine tool 10, at least one of the movable element is desirably the tool holding unit which holds the cutting tool (the rotating tool 100 or the lathe-turning tool 102), for example, the tool spindle 22 or the tool post 18. This is because, in many cases in the cutting-type machine tool 10, the tool holding unit is designed to have high rigidity, high power, and high precision, in order to enable cutting machining at high precision. By using the tool holding unit as one of the movable elements for moving the sub-tool 50, the sub-tool 50 can be more precisely moved, and the precision of machining by the sub-tool 50 can be improved.

In addition, at least one of the two movable elements is desirably the in-machine robot 30. The in-machine robot 30 in many cases has poorer rigidity, but a higher degree of freedom of motion as compared to the tool holding unit. By using the in-machine robot 30 as one of the movable elements for moving the sub-tool 50, the degree of freedom of motion of the sub-tool 50 can be further improved.

No particular limitation is imposed on the structure of the connection unit so long as the connection unit is provided on the movable element and can detachably attach the sub-tool 50. For example, on the tool spindle 22 and the tool post 18, the clamper 23 for attaching the tool holder holding the cutting tool is formed. Normally, the form of the clamper 23 is defined by standards. When the tool spindle 22 or the tool post 18 is used as the movable element, the clamper 23 may be used as the connection unit.

Alternatively, as another configuration, a dedicated connection unit may be provided on the tool holding unit, separate from the clamper 23, for attaching the sub-tool 50.

Here, no particular limitation is imposed on the type of the sub-tool 50 so long as the sub-tool 50 is a tool separate from the tool (the rotating tool 100 or the lathe-turning tool 102) held by the tool holding unit (the tool spindle 22 or the tool post 18) alone, and is held by the two movable elements. Therefore, the sub-tool 50 may be, for example, a handsaw-type tool having a sawtooth, a tool having a cutting blade portion, a tool having a restiform body, a tool having a cloth-form member used for polish machining, or the like. The sub-tool 50 desirably comprises a machining unit that actually contacts the workpiece 110 and machines the workpiece 110, a first connected unit to be detachably connected to the first movable element, and a second connected unit to be detachably connected to the second movable element. No particular limitation is imposed on structures and formation positions of the first connected unit and the second connected unit, and the first and second connected units may be provided at ends of the sub-tool 50 or at a central portion of the sub-tool 50. The machining unit of the sub-tool 50 machines the workpiece 110 by executing a machining motion such as rotation, reciprocation, random movement, or the like. The machining motion of the machining unit may be realized by the movements of the first and second movable elements, or may be realized by a motive force transferred from a motive force source which produces a motive force (such as pneumatic pressure, hydraulic pressure, electric power, magnetic power, or the like) independently from the first and second movable elements. Therefore, the sub-tool 50 may have the sawtooth or the restiform body which reciprocate along with the reciprocation of the first and second movable elements. Alternatively, as another configuration, the sub-tool 50 may be connected to a compressed air source, and have a cutting blade (machining unit) which rotationally moves by a pneumatic pressure supplied from the compressed air source.

The sub-tool 50 has two connected units to be connected to the two connection units. No particular limitation is imposed on the structure of the connected unit, so long as the connected unit can be detachably connected to the corresponding connection unit. At least one of the two connected units desirably comprises a joint which changes an orientation of the machining unit with respect to the connected unit. The joint is desirably capable of at least one of a linear movement, a rotation, and bending. Therefore, as the joint, for example, a universal joint or a ball joint may be employed. The sub-tool 50 used in one machine tool 10 is not limited to one type, and a plurality of types of the sub-tools 50 may be used. As already described, the control device 34 of the machine tool 10 stores the data related to the sub-tool 50 planned to be used; that is, the sub-tool data.

When machining is to be executed using the sub-tool 50, the operator creates a machining program indicating the movement trajectory and the machining conditions (such as a rotational rate, a feed velocity, or the like) of the sub-tool 50, and inputs the machining program into the control device 34. The control device 34 interprets the machining program block by block, and controls driving of the movable element and the dedicated drive source of the sub-tool 50, in order to realize the instructed movement trajectory. Here, at least one of the two movable elements connected to the sub-tool 50 is desirably controlled by position control having a position as a control target. In particular, because, in many cases, the tool holding unit (the tool spindle 22 or the tool post 18) has high position precision, when the tool holding unit is used as the movable element for moving the sub-tool 50, the tool holding unit is desirably position-controlled. When one of the two movable elements is position-controlled, the other movable element may be controlled by force control having a force (torque) as a control target. By employing the force control, even when a movable element having low position precision (for example, the in-machine robot 30 having poor rigidity) or the like is used as the movable element, suitable machining can be enabled.

Specific examples of the sub-tool 50 will now be described with reference to the drawings. FIG. 2 and FIG. 3 are diagrams showing an example of the sub-tool 50a. FIG. 2 is a diagram viewing the sub-tool 50a from the front, and FIG. 3 is a diagram viewing the sub-tool 50a from the side. In FIG. 2 and FIG. 3, the sub-tool 50a is a handsaw-type tool having a sawtooth 52a as the machining unit. The sub-tool 50a comprises the sawtooth 52a, a pair of connected units 54f and 54s (hereinafter, the indices f and s will be omitted when the first and second are not to be distinguished) provided on respective ends of the sub-tool 50a, and a pair of joints 56 present between the connected unit 54 and the sawtooth 52a.

The sub-tool 50a is connected to the tool spindle 22 and the in-machine robot 30 via the connected units 54. In other words, in the example configuration of FIG. 3, the tool spindle 22 and the in-machine robot 30 function as the movable elements which move the sub-tool 50a. In addition, the clamper 23 provided on the tool spindle 22 and the attachment/detachment unit 32 provided at the tip of the in-machine robot 30 function as the connection units. The first connected unit 54f inserted into the clamper 23 has the same shape as an insertion unit (a part called a shank) of a general-purpose tool holder. Because the insertion unit of the tool holder generally has a tapered shape with a narrowed tip, the first connected unit 54f also has a tapered shape with a narrowed tip. No particular limitation is imposed on the shape of the second connected unit 54s so long as the second connected unit 54s can be detachably connected to the attachment/detachment unit 32 of the in-machine robot 30, and in the example configuration shown in the figures, the second connected unit 54s also has a tapered shape with a narrowed tip.

The joint 56 which can rotate around one axis is provided between each of the connected units 54 and the sawtooth 52a. The joints 56 are normally free, and can rotate according to the end positions of the sub-tool 50a (positions of the two connected units 54). By providing the joints 56, it becomes possible to change the orientation of the sub-tool 50a in various manners.

When the machining is to be executed using the sub-tool 50, the control device 34 calculates a movement trajectory of the sub-tool 50a based on the machining program data, and calculates movement trajectories of the tool spindle 22 and the in-machine robot 30 for executing the movement trajectory. Specifically, the control device 34 moves the sub tool 50a closer to the workpiece 110 while reciprocating the sawtooth 52a in a longitudinal direction, to cut and machine the workpiece 110. In this process, the control device 34 controls both of the tool spindle 22 and the in-machine robot 30 by position control having the position as the control target.

In this manner, by connecting the sub-tool 50a to the tool spindle 22 and the in-machine robot 30, it becomes possible to bear a large part of the weight of the sub-tool 50a by the tool spindle 22, and to also realize a complicated motion of the sub-tool 50a by the movement of the in-machine robot 30. Specifically, the tool spindle 22 in many cases has high rigidity and high power, but also has a low degree of freedom of motion. On the other hand, while the in-machine robot 30 has poor rigidity, the degree of freedom of the motion is high, and various motions can be realized. As a result, by combining the tool holding unit (the tool spindle 22) and the in-machine robot 30, it becomes possible to handle a large-size tool such as a handsaw which has been difficult to handle.

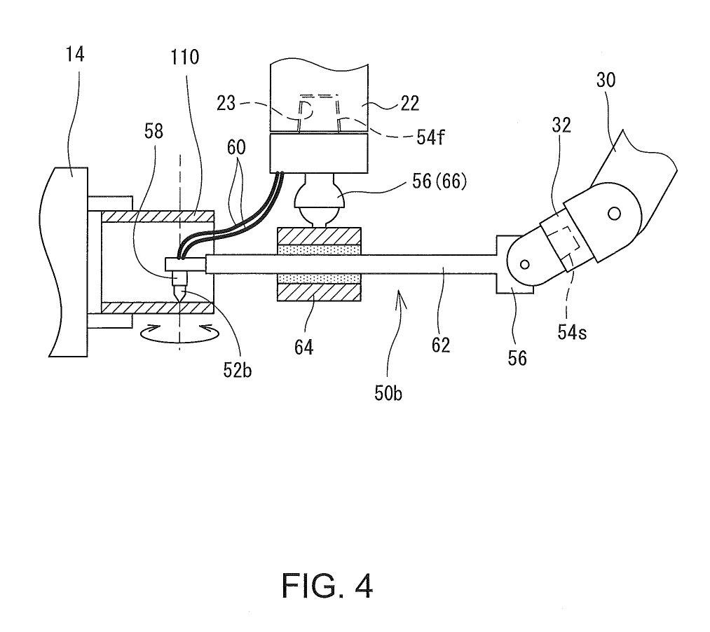

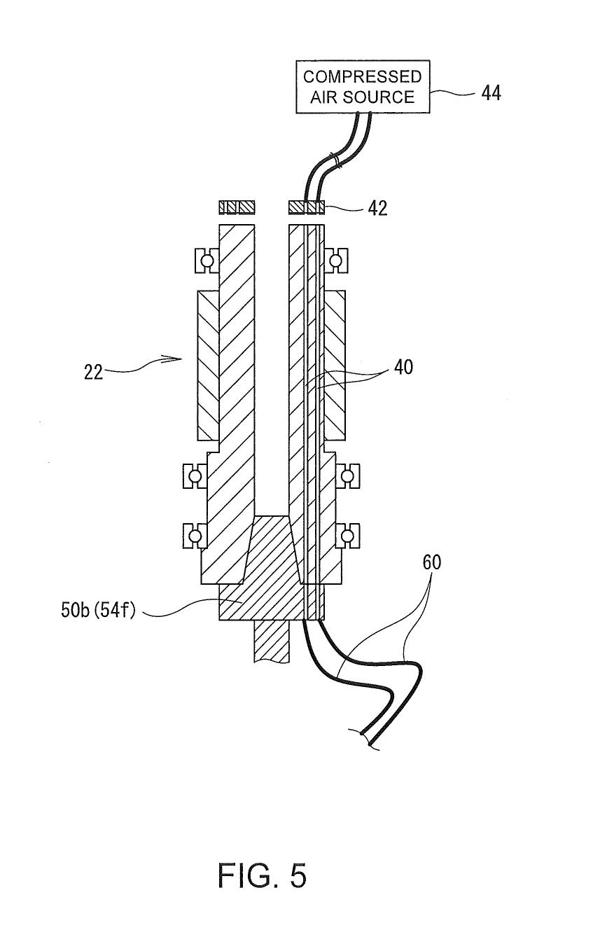

Next, another example sub-tool 50b will be described with reference to FIG. 4 and FIG. 5. FIG. 4 is a diagram showing a machining process using another sub-tool 50b, and FIG. 5 is a schematic cross-sectional diagram of the tool spindle 22 suited for the sub-tool 50b.

In FIG. 4, the sub-tool 50 has a cutting blade 52b as the machining unit, which is driven by pneumatic pressure. The cutting blade 52b is attached to an air spindle unit 58 which rotationally holds the cutting tool. When the workpiece 110 is to be cut, air is supplied to the air spindle unit 58, to rotate the cutting blade 52b at high velocity around a predetermined rotational axis.

When the sub-tool 50b is to be handled, the machine tool 10 desirably comprises a motive force source which produces motive force independently from the first and second movable elements connected to the sub-tool 50b (the tool spindle 22 and the in-machine robot 30), and a transfer mechanism which transfers the motive force produced by the motive force source to the machining unit of the sub-tool 50b (the cutting blade 52b). In the example configuration of FIG. 5, the compressed air which is the motive force is supplied to the air spindle unit 58, for example, through an air path 40 inside the tool spindle 22 and an air pipe 60 relaying the air path 40 and the air spindle unit 58.

That is, as shown in FIG. 5, the air path 40 through which the compressed air passes is formed inside the tool spindle 22. In addition, at an upper side of the tool spindle 22, an adapter 42 which can contact and separate is provided on an upper end surface of the tool spindle 22. The adapter 42 is connected to a compressed air source 44 which is the motive force source, and by the adapter 42 airtightly contacting the upper end surface of the tool spindle 22, the compressed air is supplied to the air path 40. On the other hand, when the tool spindle 22 rotates at high velocity, the adapter 42 is separated from the upper end surface of the tool spindle 22. Such a motion of the adapter 42 and the driving of the compressed air source 44 are controlled by the control device 34. The transfer mechanism of the compressed air described herein is only exemplary, and the transfer mechanism of the compressed air may be suitably changed so long as the compressed air can be supplied to the air spindle unit 58 at the end. In addition, although the air spindle unit 58 driven by the pneumatic pressure is exemplified, alternatively, there may be employed a structure which is driven by a motive force other than pneumatic pressure such as, for example, hydraulic pressure, electric power, or magnetic power.

The air spindle unit 58 is attached near one end of an elongated handle unit 62. At an approximate center of the handle unit 62, the first connected unit 54f is attached via a slide bearing 64, and a ball joint 66 (joint 56). In addition, on the other end of the handle unit 62, the second connected unit 54s is attached via the joint 56. The first connected unit 54f is connected to the clamper 23 of the tool spindle 22 and the second connected unit 54s is connected to the attachment/detachment unit 32 of the in-machine robot 30.

When the machining by the sub-tool 50b is to be executed, the control device 34 calculates a movement trajectory of the cutting blade 52b based on the machining program data, and calculates movement trajectories of the tool spindle 22 and the in-machine robot 30 for executing the movement trajectory. The control device 34 also identifies the rotational rate of the cutting blade 52b or the like based on the machining program data, and controls driving of the compressed air source 44 to realize the rotational rate. When it is desired to move a point of machining (a point of contact between the cutting blade 52b and the workpiece 110) in an axial direction or a radial direction of the workpiece 110, the control device 34 translates the tool spindle 22 and the attachment/detachment unit 32 of the in-machine robot 30 in the axial direction or the radial direction. When it is desired to move the point of machining in a circumferential direction of the workpiece 110, the control device 34 drives the workpiece spindle device 14 to rotate the workpiece 110. Further, when it is desired to change the orientation of the handle unit 62 (incline the handle unit 62), the control device 34 moves the attachment/detachment unit 32 of the in-machine robot 30 upward and downward with respect to the tool spindle 22. By combining these motions, it becomes possible to machine a large portion of an inner surface of a hollow workpiece 110 by the sub-tool 50b shown in FIG. 4.

Here, in the structure shown in FIG. 4, the other end of the sub-tool 50b is supported by the in-machine robot 30, and the central part is supported by the tool spindle 22. In other words, the sub-tool 50b is two-point supported by the two movable elements. By two-point supporting the sub-tool 50b with the two movable elements, it becomes possible to also handle a tool which is long in length, in which a large moment can be produced, and which is easily deflected. As a result, a surface which cannot be easily accessed by a normal tool, such as the inner surface of the hollow workpiece 110, can be easily machined. In addition, in the structure shown in FIG. 4, because the sub-tool 50b is connected to the motive force source independent from the movable elements; more specifically, the compressed air source 44 or the like, a larger number of variations of machining can be realized.

Moreover, in the structure of FIG. 4, when the attachment/detachment unit 32 of the in-machine robot 30 is moved upward and downward while the tool spindle 22 is maintained in a stationary state, the handle unit 62 of the sub-tool 50b swings with a center point of the ball joint 66 as a center. In other words, the sub-tool 50b functions like a lever having the attachment/detachment unit 32 of the in-machine robot 30 as a power point, the tip of the cutting blade 52b as an action point, and a periphery of the ball joint 66 as a fulcrum. In this case, by the principle of the lever, the force of the in-machine robot 30 can be multiplied several times, and acted on the workpiece 110. In addition, a ratio between a distance from the power point to the fulcrum and a distance from the fulcrum to the action point can be freely changed by moving the handle unit 62 in the axial direction with respect to the slide bearing 64, and thus, the ratio of the force can be freely changed.

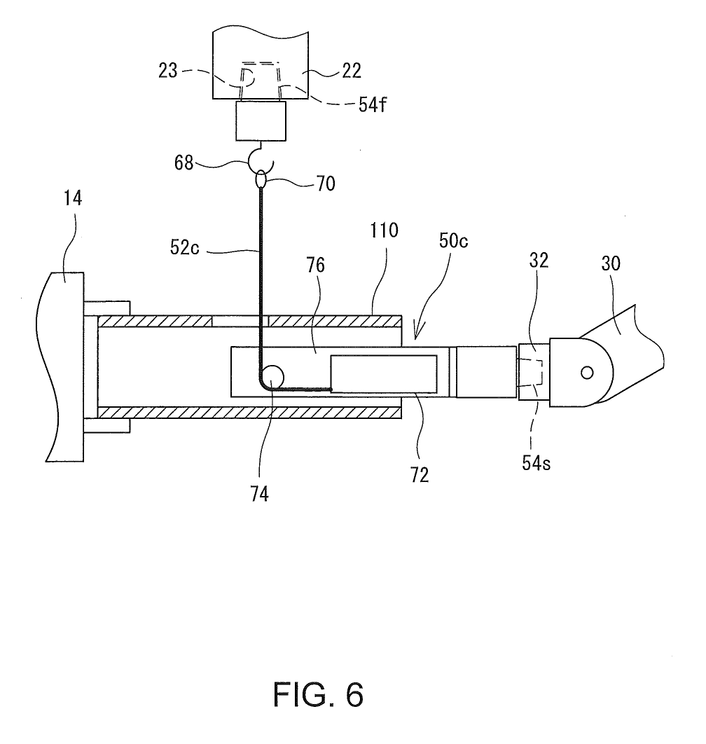

Next, a specific example of another sub-tool 50c will be described with reference to FIG. 6. FIG. 6 is a diagram showing machining by another sub-tool 50c. The sub-tool 50c has a high-tension, restiform body 52c such as a saw wire or a diamond wire as a machining unit. At a tip of the restiform body 52c, an engagement ring 70 which can engage with a hook 68 provided on the first connected unit 54f to be described later is attached.

Of the restiform body 52c, portions that are not used are housed in a wire housing unit 72. In the wire housing unit 72, a winding device (not shown) which winds the restiform body 52c is built in. In the winding device, a spring for exerting a suitable tension force to the restiform body 52c is attached, and a suitable tensioning force is caused in the restiform body 52c pulled out against the urging force of the spring. The wire housing unit 72 is attached on a base plate 76, and a pulley 74 on which the pulled-out restiform body 52c can be hooked is provided on the base plate 76. The pulled-out restiform body 52c is bent with the pulley as a boundary.

An end of the base plate 76 is connected to the second connected unit 54s, which is connected to the attachment/detachment unit 32 of the in-machine robot 30. The first connected unit 54f is connected to the tool spindle 22, and the hook 68 onto which the engagement ring 70 is engaged is attached to a tip of the first connected unit 54f.

When machining using the sub-tool 50c is to be executed, the control device 34 calculates a movement trajectory of the restiform body 52c based on the machining program data, and calculates amounts of movement of the tool spindle 22 and the in-machine robot 30 for executing the movement trajectory. Specifically, when it is desired to translate the position of the restiform body 52c, the control device 34 translates the tool spindle 22 and the attachment/detachment unit 32 of the in-machine robot 30. When it is desired to change an orientation (inclination angle) of the restiform body 52c, the tool spindle 22 may be moved in a direction orthogonal to or inclined with respect to an axial direction of the restiform body 52c (up-and-down direction on the page in FIG. 6). Further, when it is desired to cut the workpiece 110 by the restiform body 52c, the restiform body 52c is reciprocated in its axial direction in a state where the restiform body 52c contacts the workpiece 110. The reciprocation of the restiform body 52c may be realized by moving the tool spindle 22 back and forth along the axial direction of the restiform body 52c. By combining these motions, it becomes possible to cut various workpieces 110 by the sub-tool 50c.

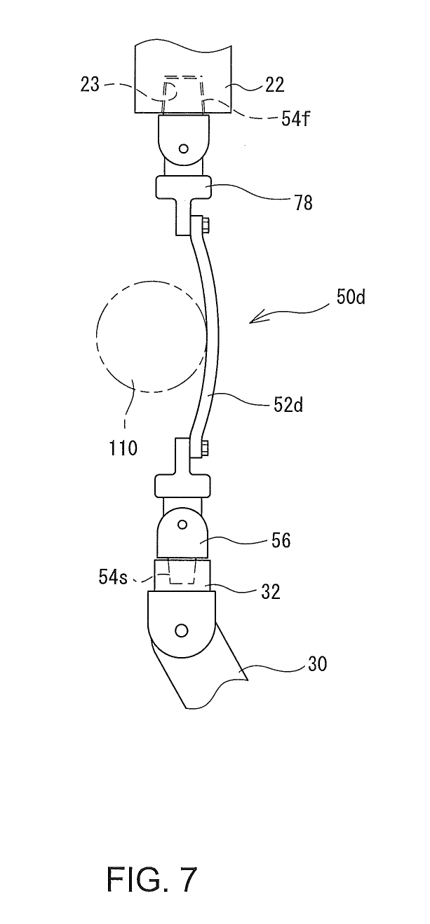

Next, a specific example of another sub-tool 50d will be described with reference to FIG. 7. FIG. 7 is a diagram showing machining by another sub-tool 50d. The sub-tool 50d has a cloth-form member 52d (for example, a cotton cloth, a linen cloth, an abrasive paper, or the like) for polishing the workpiece 110 as the machining unit. The cloth-form member 52d is attached to an attachment frame 78, which is connected to the first connected unit 54f and the second connected unit 54s via the joint 56. The first connected unit 54f is connected to the clamper 23 of the tool spindle 22, and the second connected unit 54s is connected to the attachment/detachment unit 32 of the in-machine robot 30.

When machining using the sub-tool 50d is to be executed, the control device 34 calculates a movement trajectory of the cloth-form member 52d based on the machining program data, and calculates movement trajectories of the tool spindle 22 and the in-machine robot 30 for executing the movement trajectory. Specifically, the control device 34 randomly moves the cloth-form member 52d in multiple directions in a state where the cloth-form member 52d is pressed against a surface of the workpiece 110, to polish the surface of the workpiece 110. In such a polishing machining, control of a pressing force of the cloth-form member 52d is important. Thus, in this case, the control device 34 desirably controls the tool spindle 22 by position control having the position as the control target, and controls the in-machine robot 30 by the force control having the force as the control target. With such a structure, it becomes possible to apply a suitable polishing pressure onto the workpiece 110 while the cloth-form member 52d is suitably positioned.

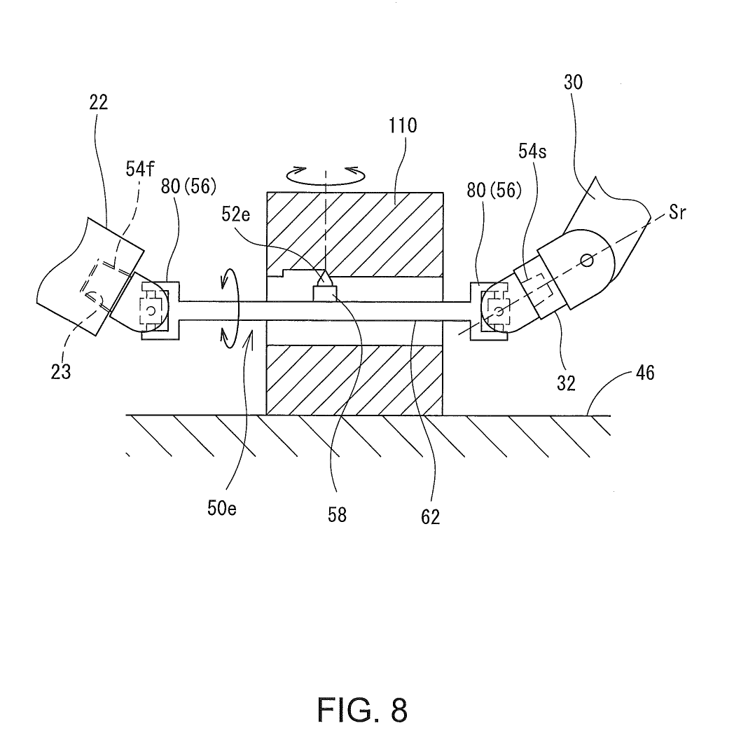

Next, a specific example of another sub-tool 50e applied to another machine tool will be described. In the above description, a multi-tasking machine has been exemplified having the workpiece spindle device 14 and the tool spindle 22. Alternatively, the technique of the present disclosure may be applied to other machine tools. For example, the technique of the present disclosure may be applied to a machine tool 10 (for example, a machining center or the like) having a table 46 on which the workpiece 110 is placed and held, in place of or in addition to the workpiece spindle device 14. FIG. 8 is a diagram showing machining of an inner surface of a circular cylindrical workpiece 110 placed on the table 46 by the sub-tool 50e. The sub-tool 50e comprises, similar to the sub-tool 50 shown in FIG. 4, a cutting blade 52e which functions as a machining unit, an air spindle unit 58 which rotates the cutting blade 52e by pneumatic pressure, and a handle unit 62 on which the air spindle unit 58 is attached. On respective ends of the handle unit 62, the first and second connected units 54f and 54s are connected via universal joints 80 (joints 56). The first connected unit 54f is connected to the clamper 23 of the tool spindle 22, and the second connected unit 54s is connected to the attachment/detachment unit 32 of the in-machine robot 30. In the machine tool 10, the attachment/detachment unit 32 of the in-machine robot 30 is configured to be rotatable around its axis Sr.

When it is desired to move a point of machining (a point of contact between the cutting blade 52e and the workpiece 110) in an axial direction or a radial direction of the workpiece 110, the control device 34 translates the tool spindle 22 and the attachment/detachment unit 32 of the in-machine robot 30 in the axial direction or the radial direction of the workpiece 110. When it is desired to move the position of the point of machining in a circumferential direction of the workpiece 110, the control device 34 rotates the tool spindle 22 and the attachment/detachment unit 32 of the in-machine robot 30. The rotation of the tool spindle 22 and the tip is transferred to the handle unit 62 via the universal joint 80, and the point of machining (the cutting blade 52e) moves in the circumferential direction of the workpiece 110. When it is desired to change the orientation of the handle unit 62 (incline the handle unit 62), the control device 34 moves only one of the tool spindle 22 and the attachment/detachment unit 32 of the in-machine robot 30. By combining these motions, it becomes possible to machine a large portion of the inner surface of a hollow workpiece 110.

A specific example of another sub-tool 50f will now be described with reference to FIG. 9. In the above description, a part of the sub-tool 50 is connected to the in-machine robot 30, but alternatively, the part of the sub-tool 50 may be connected to another movable element in place of the in-machine robot 30. For example, of various machine tools, there exists a machine tool (lathe) having an upper tool post 18u and a lower tool post 18d provided below the upper tool post 18u. In such a machine tool, as shown in FIG. 9, a part of the sub-tool 50f may be connected to the upper tool post 18u, and another part of the sub-tool 50f may be connected to the lower tool post 18d. In FIG. 9, the sub-tool 50f comprises a restiform body 52f as the machining unit. In this case, the upper tool post 18u and the lower tool post 18d may be reciprocated in an axial direction of the restiform body 52f, to cut the workpiece 110 with the restiform body 52f.

The sub-tool 50 may be configured to be automatically attachable or detachable using the in-machine robot 30 or other mechanisms. For example, in the case of the sub-tool shown in FIG. 2˜FIG. 4 and FIG. 7, a mechanism of an ATC (automatic tool changer) provided on the machine tool 10 may be used to realize the automatic attachment/detachment of the sub-tool 50. In this case, when the sub-tool 50 is to be attached, first, the first connected unit 54f of the sub-tool 50 is connected to the tool spindle 22 using the ATC. With this process, the sub-tool 50 is set in a state of being hung from the tool spindle 22. In this state, the in-machine robot 30 may be moved to a region below the sub-tool 50, and the second connected unit 54s may be inserted into the attachment/detachment unit 32 of the in-machine robot 30. As another configuration, after the sub-tool 50 is first attached to the in-machine robot 30 by the ATC, the sub-tool 50 may be transported to a region near the tool spindle 22 using the in-machine robot 30. In this case, when the sub-tool 50 is transported by the in-machine robot 30, in order to prevent fluctuation of the sub-tool 50, it is desirable to provide a mechanism for locking the joint 56 between the second connected unit 54s and the machining unit.

Further, all of the above-described structures are merely exemplary, and, so long as one sub-tool is connected to two movable elements provided in the machine tool and the sub-tool is held and moved by the two movable elements, other structures may be suitably changed. In any case, by employing a structure in which one sub-tool is connected to two movable elements, it becomes possible to handle a tool having a large size, a heavy weight, a special shape, or a special motion which has been difficult to handle by the machine tool of the related art. As a result, machining operations that are difficult to realize by the machine tool of the related art can be enabled.

1. A machine tool including a tool holding unit and a workpiece holding unit, the machine tool comprising:
a first connection unit to which a part of a sub-tool, which is a separate tool from a main tool which is held by the tool holding unit alone, can be detachably connected;
a second connection unit to which another part of the sub-tool can be detachably connected;
a first movable element that moves the first connection unit;
a second movable element that moves the second connection unit; and
a controller that controls driving of the first movable element and the second movable element, to execute machining of a workpiece by the sub-tool connected to the first connection unit and the second connection unit.

2. The machine tool according to claim 1, wherein
the controller comprises a storage unit that stores sub-tool data including a characteristic of the sub-tool, and
the controller interprets machining program data instructed by an operator, to calculate a movement trajectory of the sub-tool and to control movements of the first movable element and the second movable element based on the movement trajectory and the sub-tool data stored in the storage unit.

3. The machine tool according to claim 1, wherein
the first movable element is a tool holding unit that holds a rotating tool or a lathe-turning tool as the main tool, and
the first connection unit is an attachment unit of the main tool provided on the tool holding unit.

4. The machine tool according to claim 1, wherein
the second movable element is a robot provided in a machining chamber of the machine tool.

5. The machine tool according to claim 3, wherein
the second movable element is a robot provided in a machining chamber of the machine tool.

6. The machine tool according to claim 5, wherein
the controller controls the first movable element by position control having a position as a control target, and controls the second movable element by force control having a force as a control target.

7. The machine tool according to claim 1, wherein
the machine tool comprises a first tool holding unit and a second tool holding unit that hold a rotating tool or a lathe-turning tool as a main tool, and
the first movable element is the first tool holding unit and the second movable element is the second tool holding unit.

8. The machine tool according to claim 1, further comprising:
a motive force source that produces a motive force independently from the first movable element and the second movable element; and
a transfer mechanism that transfers a motive force produced by the motive force source to a machining unit provided on the sub-tool connected to the first connection unit and the second connection unit, wherein
a workpiece is machined by the machining unit driven by the motive force.

9. A tool to be detachably connected to a first movable element and a second movable element provided in a machine tool, the tool comprising:
a first connected unit to be detachably connected to the first movable element;
a second connected unit to be detachably connected to the second movable element; and
a machining unit that contacts a workpiece and machines the workpiece.

10. The tool according to claim 9, further comprising a joint that changes an orientation of the machining unit with respect to the first connected unit and/or the second connected unit, on at least one of between the machining unit and the first connected unit and between the machining unit and the second connected unit.

11. A control program of a machine tool that executes machining of a workpiece by one sub-tool connected to a first movable element and a second movable element, the program, when executed, causing:
a storage unit provided in the machine tool to store sub-tool data including a characteristic of the sub-tool; and
a controller provided in the machine tool to interpret machining program data instructed by an operator, to calculate a movement trajectory of the sub-tool and to control movements of the first movable element and the second movable element based on the calculated movement trajectory and the sub-tool data.
